(19) United States
(12) Patent Application Publication
(10) Pub. No.: US 2026/0310450 A1
(43) Pub. Date: Oct. 8, 2026

(54) CONTEXT-AWARE BUG GROUPING AND PRIORITIZATION SYSTEM

(71) Applicant: Microsoft Technology Licensing, LLC, Redmond, WA (US)

(72) Inventors: Shubham AGARWAL, Bengaluru (IN); Vijay SONI, Bengaluru (IN); Vinay GUPTA, Bengaluru (IN)

(21) Appl. No.: 19/098,685

(22) Filed: Apr. 2, 2025

(51) Int. Cl. G06F 8/70; G06F 16/35; G06F 16/901

(52) U.S. Cl. CPC G06F 8/70; G06F 16/35; G06F 16/9024

(57) ABSTRACT

Provided herein are systems, methods, machine-readable media, and the like, for bug mitigation in a software application. A method includes receiving a bug report associated with a bug, the bug report including a title, reproduction steps, and a description, generating, by a transformer model, respective embeddings of the title and the description resulting in a title embedding and a description embedding, generating a functional intent signature (FIS) of the bug based on the reproduction steps, clustering the bug based on the FIS, the title embedding and the description embedding, determining the bug belongs to a highest priority cluster, and mitigating the bug responsive to determining the bug belongs to a highest priority cluster resulting in an updated software application.

### TECHNICAL FIELD

Aspects of the application regard triaging bugs in software.

### BACKGROUND

Modern software development environments generate vast volumes of bug reports across multiple platforms, features, and user environments. Traditional bug triaging tools face several challenges in managing this scale and complexity. The challenges include ambiguity in bug descriptions, lack of functional understanding, challenges in handling cyclic and complex dependencies, static clustering limitations, cross-platform variance, and lack of prioritization context, among others.

### BRIEF DESCRIPTION OF DRAWINGS

FIG. 1 illustrates, by way of example, a diagram of an embodiment of a method that can be implemented by a Context-Aware Bug Grouping and Intent Matching (CABGIM) system.

FIG. 2 illustrates, by way of example, a diagram of an embodiment a method for generating S, a functional intent signature (FIS).

FIG. 3 illustrates, by way of example, a flow diagram of a method for performing the clustering operation of the method of FIG. 1.

FIG. 4 illustrates, by way of example, a diagram of an embodiment of a CABGIM system to implement the method of FIGS. 1-3, 5, or a portion thereof.

FIG. 5 illustrates, by way of example, a diagram of an embodiment of a method for bug management.

FIG. 6 illustrates, by way of example, a block diagram of an embodiment of a machine in the example form of a computer system within which instructions, for causing the machine to perform any one or more of the methodologies discussed herein, may be executed.

### DETAILED DESCRIPTION

The following description and the drawings sufficiently illustrate teachings to enable those skilled in the art to practice them. Other embodiments may incorporate structural, logical, electrical, process, and other changes. Portions and features of some examples may be included in, or substituted for, those of other examples. Teachings set forth in the claims encompass all available equivalents of those claims.

Traditional bug triaging tools face several challenges in managing this scale and complexity. The challenges include ambiguity in bug descriptions, lack of functional understanding, challenges in handling cyclic and complex dependencies, static clustering limitations, cross-platform variance, and lack of prioritization context, among others.

Ambiguity in bug descriptions: many bug reports for different bugs often contain similar language or keywords, leading to misgrouping of issues with different root causes. For example, a first bug report can state “A crash in “Calendar View” may be caused by a UI rendering issue” and a second bug report can state “an API authentication failure”.

Lack of functional understanding: current systems rely heavily on textual similarity, failing to capture the functional behavior or intent behind the bug. For example, two bugs can have identical descriptions but differing reproduction steps. Two bugs can be described as “crash when selecting calendar tab”. A first bug can have the functional sequence of “Click on calendar tab→Crash” and a second bug can have the different functional sequence of “Login→Navigate to calendar tab→Crash”. Each of these bugs, however, may have distinct root causes.

Challenges in handling cyclic and complex dependencies: bugs often exhibit interdependencies or cyclic relationships that are not captured by static clustering approaches.

Static clustering limitations: conventional clustering approaches are unable to adapt to evolving bug patterns or incorporate triage personnel feedback, leading to poor long-term accuracy.

Cross-platform variance: bugs with similar symptoms on different platforms (e.g., iOS vs. Android) may have entirely different root causes, which current systems fail to differentiate between.

Lack of prioritization context: existing tools do not account for real-world factors like platform importance, user base size, or recurrence frequency, resulting in suboptimal bug prioritization.

Limitations of existing solutions for bug triage and mitigation include overreliance on vector similarity, manual effort for deduplication, inability to handle dynamic bug patterns, and a lack of graph-based analysis. Most bug tracking systems use vector similarity models based on natural language embeddings, which fail to capture functional or contextual nuances. Using vector similarity, the bugs are represented as vectors of bug features. The vectors are then compared, such as by a similarity or distance metric, to determine bug similarity. Triager personnel often manually mark duplicates or related bugs, increasing overhead and delaying resolution timelines. Static rule-based systems cannot adapt to changes in bug patterns or incorporate feedback effectively. Existing solutions do not utilize graph theory to analyze complex relationships between bugs, leading to fragmented and incomplete groupings.

A context-aware bug grouping and intent matching (CABGIM) system addresses the challenges and limitation of the existing solutions. CABGIM combines two or more of multi-dimensional graph analysis, functional intent signatures, adaptive learning mechanisms, or contextual prioritization to overcome one or more of the challenges and limitations of existing solutions. The multi-dimensional graph analysis captures semantic, functional, and contextual relationships between bugs. The functional intent signatures encode functional behavior as mathematical vectors to differentiate bugs (example associated bug reports are presented below) with similar language but distinct root causes. The adaptive learning mechanisms continuously improve clustering accuracy and duplicate detection through feedback loops and contrastive learning. The contextual prioritization ranks bugs based on real-world impact factors like recurrence frequency, platform criticality, and user base size. By integrating these innovations, the system ensures precise grouping, intent disambiguation, and prioritization of bugs, transforming the efficiency and effectiveness of bug triaging in modern software ecosystems.

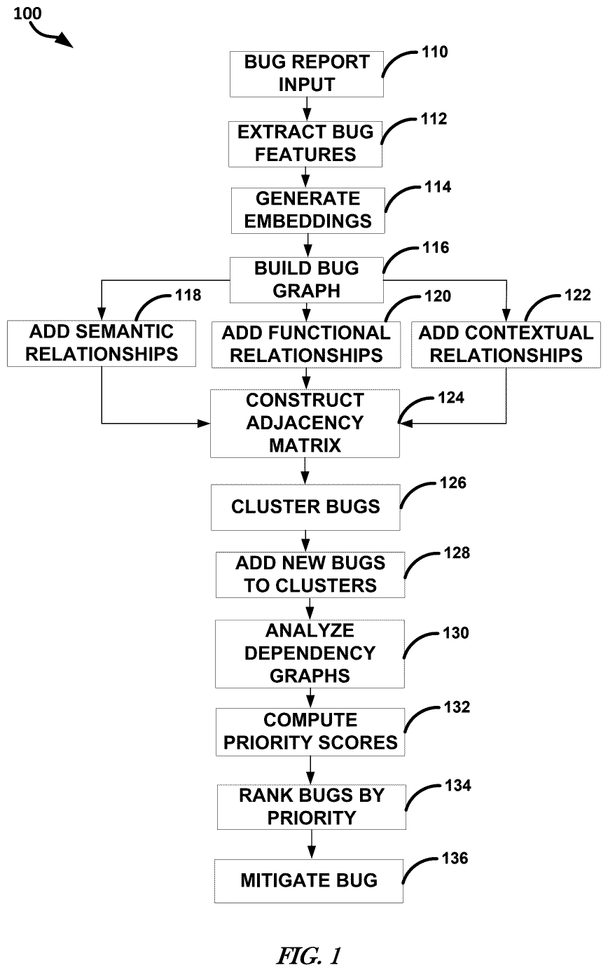

FIG. 1 illustrates, by way of example, a diagram of an embodiment of a method 100 for bug mitigation. The method 100 can be implemented by a CABGIB system, or a portion thereof. The method 100 as illustrated includes receiving a bug report at operation 110, extracting bug features from the bug report at operation 112, generating embeddings at operation 114, building a bug graph at operations 116, 118, 120, 122, constructing an adjacency matrix at operation 124, clustering bugs at operation 126, adding new bugs to clusters at operation 128, analyzing dependency graphs at operation 130, computing priority scores at operation 132, ranking bugs by priority at operation 134, and mitigating a bug at operation 136. Each operation is described in more detail.

At operation 110, a bug report is received. The bug report includes a natural language description of the bug (typically provided by a user). The natural language description can include a title, description, and metadata. The title is a high-level description of the bug. The description is a lower-level description of the bug that provides more detail, sometimes including steps performed prior to, and up to, experiencing the bug. The metadata can include a date and time that the report was submitted, application data, such as an application name, version, or the like, an operating system that executed the application, a combination thereof, or the like.

At operation 112, bug features can be extracted based on the bug report. The features can include the title, description, metadata, and reproduction steps. The reproduction steps are the operations performed within the application to cause the bug.

At operation 114, embeddings of the features can be generated. Embeddings can be generated for each of the semantic, functional, and contextual aspects of the bugs. Semantic aspects include the natural language descriptions from the bug report, such as the title and description. Semantic, contextual, and functional aspects can be embedded using GloVe, Word2Vec, BERT, fasText, DeepWalk, GraphSAGE, a convolutional neural network (CNN), a combination thereof, or the like. Functional aspects include the reproduction steps. Functional aspects can be embedded using contextual aspects include the metadata.

The operations 116, 118, 120, 122 regard generating aspects of a multi-dimensional bug graph. The graph represents bugs as nodes in a graph, with edges capturing relationships between the bugs. The relationships can be semantic, functional, contextual, or a combination thereof. Semantic relationships (bugs with similar language) can be indicated by added edges at operation 118. Functional relationships (bugs with similar reproduction steps) can be indicated by added edges at operation 120. Contextual relationships (bugs with similar metadata) can be indicated by added edges at operation 122. Semantic relationship can be determined through a text-based analysis. Reproduction steps and root causes can be indicated by reproduction step and root cause analysis. Contextual relationships can be determined through text-based analysis of the metadata.

At operation 124, the graph can be converted into a weighted adjacency matrix. The matrix can include bugs listed as rows and columns. Entries in the matrix can indicate how strongly corresponding bugs are to each other. A stronger correlation indicates that the bugs are more likely the same or otherwise related to each other. An example adjacency matrix is present below.

One or more clustering algorithms can be applied to the adjacency matrix at operation 126. The clustering technique can include spectral clustering. Spectral clustering uses the spectrum (eigenvalues) of the similarity matrix (“adjacency matrix”) of the data to perform dimensionality reduction before clustering in fewer dimensions. The similarity matrix is provided as an input and consists of a quantitative assessment of the relative similarity of each pair of points in the dataset. Spectral clustering produces cohesive clusters of related bugs.

At operation 128, new bug reports are analyzed and the corresponding bugs are added to respective appropriate clusters. The bugs can be added to the cluster for which it has a strongest correlation based on the semantic relationships, functional relationships, contextual relationships, or a combination thereof.

The clusters can be validated at operation 130, by analyzing the graph and corresponding added relationships. Groupings can be analyzed through code dependencies and interrelationships between the bugs.

Priority scores can be determined based on platform importance, recurrence, severity, or a combination thereof, at operation 132. A priority score can be determined as a weighted combination of the platform importance, recurrence of the bug being reported, severity in terms of security to the application, user data, a combination thereof, or the like.

At operation 134, bug groups (clusters) can be ranked based on the priority scores of the bugs in the cluster. Clusters with higher average priority scores can be considered more important in a ranking of the bugs at operation 134. Bugs that are ranked higher are deemed to be higher priority and in need of mitigation faster than bugs in other groups.

At operation 136, the highest priority bug or bugs can be mitigated. Mitigating a bug can include altering the code of the application, or a file or other data on which the application relies for operation. The code, file, or other data is altered so that the bug is no longer present and a corresponding error, vulnerability, or otherwise unexpected behavior or consequence of executing the application is no longer an issue.

The method 100 as illustrated includes representing bug reports as nodes in a multi-dimensional graph. In the graph, edges encode relationships based on semantic, functional, and contextual dimensions. Each bug report is represented as a node B, with the following components: title embedding, T, description embedding, D, metadata embedding, M, and a functional intent signature, S. The title embedding can be generated using a transformer-based model, such as BERT or GPT, to capture the semantic meaning of the bug title. The description embedding is separate from the title embedding but can be generated using the same transformer-based model as the title embedding based on the bug description in the bug report. The metadata embedding encodes metadata such as platform (e.g., iOS, Android), operating system (OS) version, environment, timestamps, and area path. The functional intent signature is a unique vector derived from functional behavior analysis and described below. Mathematically, a bug node is represented as Equation 1:

$$B = ( T , D , M , S ) \qquad Equation 1$$

The edges between nodes, added at operations 118, 120, 122 represent relationships based on the following criteria. A semantic similarity edge (ωₛ) measures textual similarity between bug titles (T) and descriptions (D) using cosine similarity, angular distance, or other embedding space distance metric. An example way to measure semantic similarity is provided in Equation 2:

$${ω}_{s} = {λ}_{x} \frac{\vec{{T}_{1}} \cdot {\vec{T}}_{2}}{‖ \vec{{T}_{1}} ‖ \cdot ‖ \vec{{T}_{2}} ‖} + {λ}_{y} \frac{\vec{{D}_{1}} \cdot {\vec{D}}_{2}}{‖ \vec{{D}_{1}} ‖ \cdot ‖ \vec{{D}_{2}} ‖} . \qquad Equation 2$$

Cosine similarity and angular distance focus on the angle between vectors, capturing semantic meaning while ignoring magnitude differences. This is helpful for comparing text embeddings where the direction encodes meaning. λₓ and λ_{y} are tunable parameters that control the importance of the title and description embeddings.

The functional similarity edge (ω_{f}) measures the similarity between functional intent signatures (S), such as by using Euclidean distance or another distance metric. An example way to measure similarity between functional intent signatures is provided in Equation 3:

$${ω}_{f} = \frac{1}{1 + ‖ {s}_{1} - {s}_{2} ‖} . \qquad Equation 3$$

Euclidean distance measures a straight-line distance between two points. For functional intent signatures (S), this distance works well because it directly shows how similar or different two system behaviors are—smaller distances mean more similarity, larger distances mean less similar behaviors.

The contextual similarity edge (ω_{c}) measures the overlap in metadata (M), such as by using a Jaccard similarity metric or a similar metric. An example way to measure contextual similarity is provided in Equation 4:

$${ω}_{c} = Jaccard ( {Metadata}_{1} , {Metadata}_{2} ) . \qquad Equation 4$$

Jaccard similarity measures the overlap between sets, making it helpful for comparing metadata (M) like platform or environment. Using Jaccard similarity, more shared attributes mean higher similarity, while fewer shared attributes mean lower similarity.

The operation 124 generates an adjacency matrix to represent the graph constructed at operation 116, 118, 120, 122. The graph can be represented as an adjacency matrix A, where each element A[i][j] is computed as a weighted sum of edge similarities as in Equation 5:

$$A [ i ] [ j ] = {λ}_{s} {ω}_{s} + {λ}_{f} {ω}_{f} + {λ}_{C} {ω}_{C} . \qquad Equation 5$$

Here, λₛ, λₛ, and λ_{c} are tunable parameters that control the importance of each similarity type.

The FIS, S, as discussed previously, is a representation of a bug's functional behavior derived from its execution flow, such as reproduction steps, stack traces, and system events. S encodes the functional behavior of the bug as a unique mathematical signature, enabling the system to differentiate bugs with similar descriptions but distinct root causes and to group those with shared root causes. S can be generated based on a functional transition matrix. S is a compact, numerical representation of a bug's behavioral flow. Instead of relying solely on the title or description in the bug report, S focuses on the sequence of actions (e.g., reproduction steps) that lead to the bug and summarizes them into a small vector. This helps group bugs with similar behaviors, distinguish those with different root causes, and ignore irrelevant actions (noise).

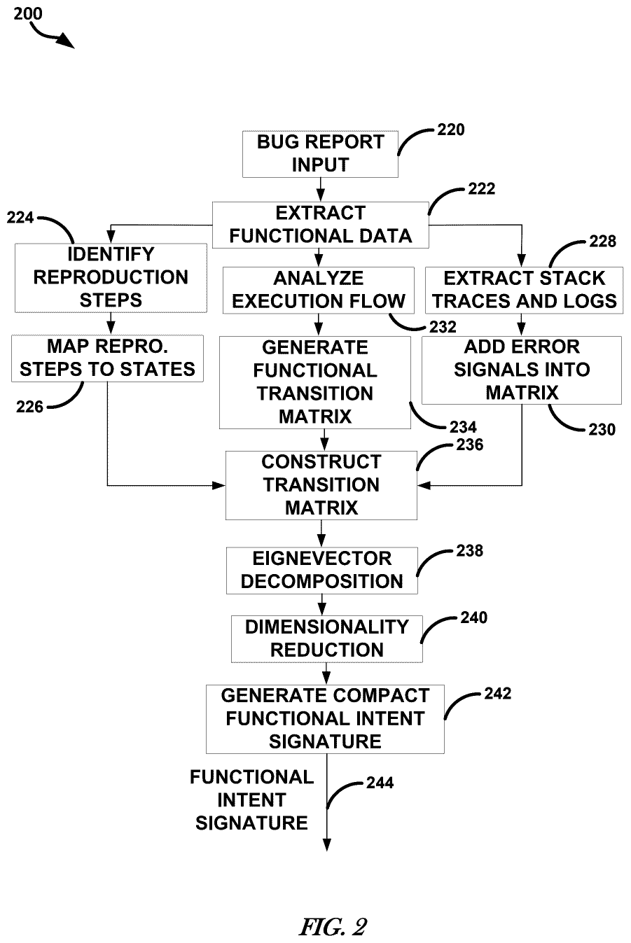

FIG. 2 illustrates, by way of example, a diagram of an embodiment a method 200 for generating S. In generating S, the bug report is received at operation 220. Then S 244 is generated by extracting functional data from the bug report at operation 222 and then executing three tracks, such as in parallel, to provide input to an operation 236 that produces a transition matrix. Eigenvector decomposition is performed at operation 238 on the transition matrix constructed at operation 236. Dimensional reduction can be performed on the Eigenvector decomposition at operation 240 resulting in a dimensionally-reduced decomposition. S 244 can be generated based on the dimensionally-reduced decomposition at operation 242. Generating the transition matrix is now described and followed by further description of the operations 238, 240, 242.

At operation 224, reproduction steps are identified. Reproduction steps are the operations performed by a use, in sequence, to realize the bug in the bug report. At operation 226, the reproduction steps are mapped to states. Each reproduction step is treated as a distinct state in a sequence. For example, consider the following reproduction steps that are mapped to states, rₓ: r₁: “Log in”, r₂: “Navigate to Calendar”, r₃: “Click on Calendar Tab”, r₄: “Crash occurs”. These states represent the functional flow that the user performs, using the application, that lead to the bug.

At operation 232, execution flow of the application is performed. By analyzing the execution flow, transition probabilities between states of the bug can be determined. At operation 234, the transition probabilities between the states of the bug can be memorialized in a functional transition matrix, F. F is a square matrix where each element F[i][j] represents the probability of transitioning from state rᵢ to state rⱼ. For example F[1][2] is the probability of transitioning from “Log in” to “Navigate to Calendar” and F[3][4] is the probability of transitioning from “Click on Calendar Tab” to “Crash occurs.” The transition probabilities are calculated based on the observed sequence of repro steps. If a step rᵢ is followed by rⱼ multiple times across bug reports, the transition probability F[i][j] increases accordingly. This can be represented mathematically as in Equation 6:

$$F [ j ] [ j ] = \frac{Number of transitions from {r}_{i} to {r}_{j}}{Total transitions from {r}_{i}} . \qquad Equation 6$$

For example, if 80% of users navigate from “Log in” to “Navigate to Calendar,” F[1][2]=0.8.

A simple example transition matrix is now provided based on the reproduction steps provided previously: r₁: “Log in”, r₂: “Navigate to Calendar”, r₃: “Click on Calendar Tab”, r₄: “Crash occurs”. Considering only this one instance of application execution, the transition matrix F look like the following matrix:

$$A = [ \begin{matrix}0 & 1 & 0 & 0 \\ 0 & 0 & 1 & 0 \\ 0 & 0 & 0 & 1 \\ 0 & 0 & 0 & 0\end{matrix} ]$$

In the matrix, A, F[1][2]=1: 100% transition probability from “Log in” to “Navigate to Calendar”; F[2][3]=1: 100% transition probability from “Navigate to Calendar” to “Click on Calendar Tab”; F[3][4]=1: 100% transition probability from “Click on Calendar Tab” to “Crash occurs”.

The transition matrix (F) uses probabilities to show how likely it is to move from one state to the next state in the bug reproduction process. This captures behavioral patterns, highlights critical function paths, and reduces bias from outliers. Capturing behavioral patterns highlights high probabilities (e.g., 0.8 or 0.9) that show consistent transitions between states, indicating that these states are important in the behavior of the bug. Low probabilities (e.g., 0.1 or 0.05) indicate rare or random transitions, which might be noise or are otherwise less important. By analyzing the probabilities, the CABGIM can identify the critical path that most users follow to reproduce the bug (e.g., “Log in→Open Calendar→Crash”). Instead of treating all transitions equally, probabilities ensure that common behavior is prioritized over rare or outlier behavior.

Operation 228 includes extracting stack traces and log data. Operation 230 includes incorporating the stack traces and log data into the transition matrix. Stack traces provide the sequence of function calls leading to an error (e.g., NullPointerException in CalendarViewRenderer.java at line 45). Logs contain error messages, timestamps, and system states (e.g., 2025 Mar. 10 14:00:00 [ERROR] NullPointerException). At operation 228, stack traces and logs can be analyzed to extract error type, location, and call sequence. This data can be converted into embeddings using models like BERT or GPT for numerical representation.

At operation 230, error signals are added to the transition matrix. Error signals include error type (e.g., IOException), error location (file/function), and call sequence patterns.Transition probabilities (F[i][j]) can be adjusted for states linked to errors (e.g., “Click on Calendar Tab”→“Crash occurs”). Error embeddings are added to the matrix for enhanced differentiation. Example: F′[i][j]=F[i][j]+Error. The error provides precision by differentiating bugs with similar steps but distinct errors (e.g., NullPointerException vs. TimeoutException). The error allows for prioritization, with transitions with severe or frequent errors getting higher weights. Further, FIS can include both functional flow and error context, making grouping more accurate.

Consider an example bug with input: (i) Steps: Log in→Navigate to Calendar→Click→Crash, and (ii) Error Log: NullPointerException in CalendarViewRenderer.java. A transition matrix without error consideration can be as follows

$$A = [ \begin{matrix}0 & 1 & 0 & 0 \\ 0 & 0 & 1 & 0 \\ 0 & 0 & 0 & 1 \\ 0 & 0 & 0 & 0\end{matrix} ] .$$

A transition matrix with error considerations can be as follows:

$$A = [ \begin{matrix}0 & 1 & 0 & 0 \\ 0 & 0 & 1 & 0 \\ 0 & 0 & 0 & 1 + {E}_{NullPointerException} \\ 0 & 0 & 0 & 0\end{matrix} ] .$$

Stack traces and logs provide error-specific details. These signals enhance the transition matrix by linking functional states with errors. This improves bug grouping, prioritization, and root cause identification.

After F is constructed, the system generates S by using dimensionality reduction, at operation 240, on eigenvectors of F that are determined at operation 238. These operations 238, 240 reduce the dimensionality of the matrix, F, while retaining its most relevant behavioral information.

At operation 238, Eigenvectors of F are determined. The Eigenvectors are computed from the matrix F to capture the underlying patterns in the transition probabilities. Eigenvectors can be thought of as directions that maximize the variance in the transition probabilities. They reveal the principal behaviors or “modes” of the functional flow. For example if a dominant Eigenvector corresponds to the behavior “Log in→Navigate to Calendar→Crash occurs,” it signifies that this is the primary functional flow of the bug.

The operation 240 can include using principal component analysis (PCA), linear discriminant analysis (LDA), singular value decomposition (SVD), or the like. The transition matrix F may be large and complex (especially for bugs with many repro steps). The operation 240 reduces the dimensionality of the eigenvectors while preserving the most significant behavioral information. The operation 240 identifies the Eigenvectors with the highest Eigenvalues (i.e. the most important patterns in the data). These eigenvectors are used to construct a lower-dimensional representation of F, that captures the essence of the bug's functional behavior. This lower-dimensional representation of F is called the functional intent signature, S. This is represented by Equation 7: S=DimensionReduction(Eigenvectors(F)) Equation 7. S is a compact vector encoding of the behavior of the bug.

The operation 240 removes redundant or less significant information from the transition matrix, F, focusing only on the most relevant functional patterns. By reducing the dimensionality, the signature becomes computationally efficient to store, compare, and cluster. The resulting signature S 244 uniquely encodes the bug's functional behavior, making it easy to identify bugs with shared root causes or distinct behaviors.

An example of dimensionality reduction is now provided. Suppose the original transition matrix F has 10 reproduction steps/states, resulting in a 10×10 matrix. The operation 240 might reduce F to a 2-dimensional signature, such as: S=[0.87,0.49]. This compact representation retains the most important behavioral characteristics of the bug, enabling efficient comparison with other bugs.

The FIS, S, can be used for bug comparison such as for deduplication, bug clustering at operation 126, root cause identification, intent matching, a combination thereof, or the like. Bugs can be compared by calculating the similarity between their signatures S1 and S2 using distance metrics (e.g., cosine similarity, Euclidean distance, or the like). Bugs with similar signatures are likely to share the same functional behavior. Bugs with similar signatures can be grouped together in a cluster, even if their textual descriptions differ. Bugs with matching or otherwise similar functional signatures likely share the same root cause, enabling faster debugging. Aspects of new bug reports can be compared against existing signatures to determine if they belong to an existing cluster or if they represent a novel issue.

F and S capture the functional flow of the bug, reducing ambiguity caused by similar textual descriptions. F and S focus on “what happens” during the bug's occurrence, not just “how it's described” by the user. F and S convert complex functional flows into compact signatures for fast comparison and clustering. F and S work effectively for bugs with long or complex reproduction steps, making them suitable for large-scale systems.

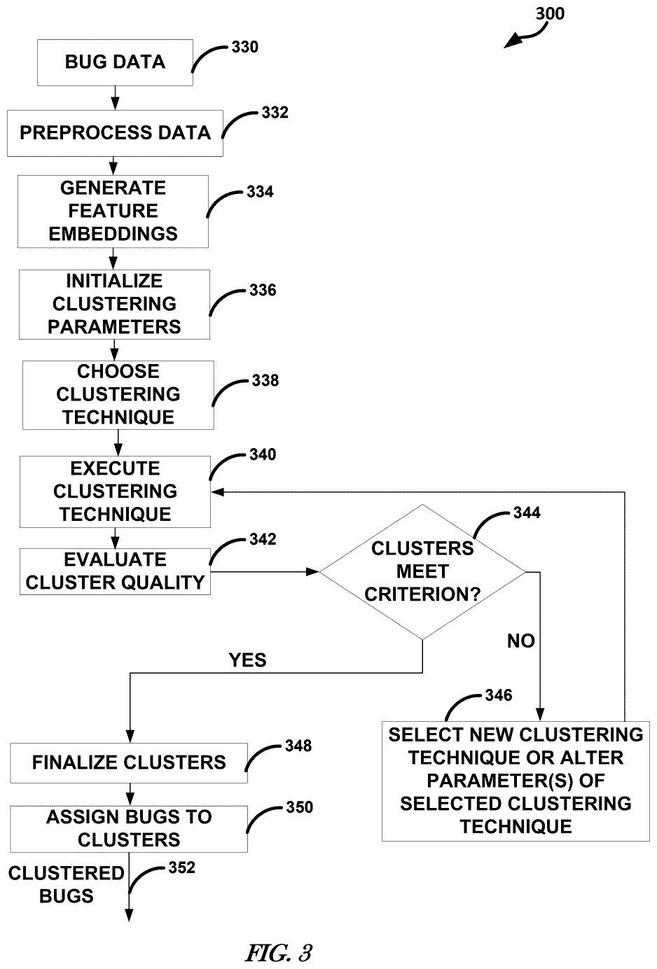

The operation 126 is now described in more detail with reference to FIG. 3.

FIG. 3 illustrates, by way of example, a flow diagram of a method 300 for performing the clustering operation of the method 100 of FIG. 1. The method 300 as illustrated includes retrieving or receiving bug data, at operation 330; preprocessing the bug data, at operation 332; generating feature embeddings, at operation 334; initializing clustering parameters, at operation 336; choosing a clustering technique, at operation 338; executing the clustering technique, at operation 340; evaluating cluster quality, at operation 342; determining whether the clusters meet criterion, at operation 344, finalizing the clusters, at operation 348; and assigning bugs to cluster, at operation 350, resulting in clustered bugs 352. Optionally, a new clustering technique can be selected or parameters of the selected clustering technique can be adjusted at operation 346, such as if the clusters do not meet the criterion, at operation 344.

The bug data from operation 330 can be a dataset of bugs, including their embeddings or feature vectors. The operation 332 can include normalizing and cleaning the data to prepare it for clustering (e.g., removing noise, scaling values, removing outliers, a combination thereof, or the like). The operation 334 can include transforming the bug data into feature embeddings (e.g., semantic, functional contextual, a combination thereof, or the like).

Setting the initial parameters at operation 336 can include setting a number of clusters to be used, a distance metric to be used in producing the cluster, a similarity threshold that indicates whether the bug is part of a given cluster, a combination thereof, or the like. Types of clustering techniques that can be chosen at operation 338 include K-means clustering, density-based spatial clustering of applications with noise (DBSCAN), or spectral clustering, among others. The operation 338 can include selecting the clustering technique based on characteristics of the bug data.

The operation 342 includes applying the chosen clustering technique to the feature embeddings generated at operation 334 to group the bugs into clusters. The operation 344 assess the quality of the clusters using metrics like a silhouette score, Davies-Bouldin index, or manual inspection. If the clusters meet the criterion, the method 300 proceed to finalize the clusters at operation 348. If the clusters do not meet the criterion, the method 300 can proceed to adjust the clustering approach, such as by selecting a different clustering technique or altering a parameter of the clustering technique. Altering the parameters of the clustering technique can include adjusting one or more of the parameters initialized at operation 336. Clustering can then be performed again using the new technique or the prior technique with new parameters.

Finalizing the clusters at operation 348 includes recording the clusters along with a unique identification that identifies the bug report(s) associated with each bug in each of the clusters. The operation 350 can include adding further bugs to the finalized clusters based on a similarity metric. The result is a list of clusters along with the bugs assigned to each of the clusters.

Adaptive Clustering is a method used to group related bugs together based on their behavior, context, and similarity. The goal is to organize bugs into clusters (groups) so that similar bugs can be addressed together, making debugging and triaging more efficient. The process is called “adaptive” because it evolves and improves with feedback from users (e.g., bug triagers).

The operation 126 can include multiple steps of clustering. In the first step of clustering, groups of bugs into broad clusters based on their relationships, which are represented by a graph and an adjacency matrix, A. The graph imagines bugs as nodes in a graph, and the connections (edges) between them represent how similar the nodes on each end of the edges are to each other. In other words, the adjacency matrix, A, is a table in which (A[i][j]) shows how similar Bugᵢ is to Bugⱼ. A graph Laplacian can be determined based on the adjacency matrix. The Laplacian, L, can be determined as L=D−A, where D is the degree matrix (D[i][j]=ΣⱼA[i][j]), which represents the total connections for each bug (how many bugs it is similar to) and A is the adjacency matrix. The Eigenvectors of L can then be determined. These eigenvectors help identify patterns and clusters in the graph of bugs. A clustering technique, such as k-means clustering, can be performed on the eigenvectors to group bugs into clusters.

Hierarchical refinement can then be performed to refine the clusters further. Hierarchical clustering is a more detailed method of clustering than k-means clustering. Using hierarchical refinement, within each cluster (e.g., calendar bugs), the system looks for subgroups using additional metrics like: functional similarity (how similar the bugs are in their behavior), contextual similarity (factors like platform, environment, or error types), a combination thereof, or the like. The second clustering splits the broad clusters into smaller, more specific groups. For example, a cluster of calendar bugs can be split into subgroup 1.1: bugs affecting calendar syncing; and subgroup 1.2: bugs affecting calendar user interface (UI).

The clustering from operation 126 can be improved using adaptive learning. With adaptive learning the system continuously learns and improves the clustering process by incorporating feedback from bug triagers (i.e. human experts). The operation 126 can be trained to differentiate bugs with distinct behaviors or root causes. The operation 126 can use a special loss function to ensure bugs that are unrelated are pushed further apart in similarity. Such as loss function is provided in Equation 7:

$$ℒ = - log \frac{exp ( sim ( {x}_{i} , {x}_{j} ) )}{{\sum }_{k} exp ( sim ( {x}_{i} , {x}_{k} ) )} . \qquad Equation 7$$

Using this loss function, the operation 126 minimizes the similarity between unrelated bugs while maximizing similarity for related ones.

Using a feedback loop, the operation 126 can further learn from feedback from bug triagers. Bug triagers can provide feedback, such as: “These bugs are actually related” and the clusters can be merged at operation 126 or “These bugs are different” and the cluster can be split at operation 126. The system adjusts its clustering rules, thresholds, and similarity metrics based on this feedback to be become more accurate over time.

The operation 126 can use a depth-first search (DFS) to identify and handle cyclic dependencies in bug relationships. For example if Bug A links to Bug B (Bug A and Bug B include an edge therebetween), and Bug B links back to Bug A, Bug A and Bug B can be grouped together as a single cyclic cluster. To handle outliers, bugs with weak connections (edges with low similarity scores) can be flagged as unique issues. For example, a bug that corresponds to a minor typo in a text label, might not depend on or affect any other bug and is therefore an outlier (a bug that is to be in a cluster with no other bugs). Bugs matching multiple clusters can be assigned to the most relevant group based on CPS (i.e., which group is most critical or has the highest priority). For example, a bug involving Login might also affect Authentication and Session Management clusters. The bug can be assigned to the cluster that is deemed to be most important according to the CPS.

The operations 128, 350 can include bug intent matching. Bug intent matching is the process of comparing the new bug against all the existing bug groups to find the best match. If a match is found, the new bug is added to the group. If no match is found, the bug is treated as the first bug in a cluster as is represents a new type of bug that was not represented by prior clusters. Bug intent matching can be performed using multi-dimensional similarity scoring. The operations 128, 350 can include determining similarity scores across multiple dimensions (semantic, functional, contextual, or the like) for the new bug and existing groups. Threshold-based filtering can be performed based on context-aware thresholds. For example, bugs associated with a same platform and error signature can be prioritized and bugs with different platforms can be deprioritized unless other similarities are high. This is accomplished by weighting the contextual and functional similarity of the bug higher in the similarity score calculation relative to the semantic similarity. This filtering ensures that the system focuses on the most likely matches, saving time. Bug intent matching can further include dependency graph matching. The dependency graphs of bugs that survive filtering can be compared. The dependency graph matching helps confirm the root cause of the new bug matches an existing group. The dependency graph is created for each bug, showing the relationships between the code modules of an application involved in the bug. In the dependency graph, nodes represent code modules (e.g., LoginHandler, CalendarView, or the like) and edges represent how these modules depend on each other (e.g., function calls, shared libraries, or the like). The operation 128 compares the dependency graph of the new bug with those of existing bug groups that have survived filtering. If the graphs are similar (e.g., they involve the same code modules and dependencies), this is a strong indicator that the bugs share the same root cause.

The operation 132 can include context-aware prioritization. Context-aware prioritization helps ensure high-impact bugs are addressed first. A contextual priority score (CPS) can be determined for each bug. The CPS is a score that indicates how urgent it is to fix a bug. The CPS can be determined using Equation 8: CPS=α·Wₚ+β·Wᵣ+γ·W_{f} Equation 8. In Equation 8, Wₚ is a platform weight that indicates how critical the platform is (e.g., production vs. testing, or iOS vs. Android) to the bug, Wᵣ is a recurrence weight that indicates how often the bug happens, how many users are affected, or a combination thereof, and W_{f} is a functional impact weight that indicates relative usage of the functionality of the application to the functionality impacted (relative to overall use of the application), and α, β, γ are tunable parameters that indicate the importance of the platform, recurrence, and functional weights. Some factors considered in the CPS can include user base size, platform criticality, and recurrence frequency. Platforms with larger user bases can be given higher priority, such as by increasing β. Bugs in critical platforms (e.g., production environments) can be prioritized, such as by increasing α. Bugs with high recurrence rates can be escalated, such as by increasing β.

Regarding scalability, scalability is about ensuring that the bug tracking system can handle large numbers of bugs and keep working efficiently as the system grows. Whether there are hundreds or millions of bug reports, the system that implements that method 100 needs to process, group, and prioritize bugs quickly and reliably without slowing down. Scalability can be achieved through efficient graph processing and vector databases. As described, bugs and their relationships (dependencies, similarities) are organized as a graph (nodes=bugs, edges=connections between bugs). The system then uses advanced algorithms like spectral clustering and depth-first search (DFS) to analyze the graph efficiently, even for large datasets. These algorithms are optimized to handle thousands or millions of nodes and edges without overwhelming the system. Each bug can be represented as a vector (a numerical summary of its behavior, description, and context. The system stores these vectors in vector databases (e.g., Pinecone, Weaviate, or the like) that allow for fast similarity searches. For example, when a new bug is reported, the system can quickly compare it to millions of existing bugs to find matches, if any exist, within seconds. Vector databases are designed for speed and scale, making searches instant, even with large amounts of data.

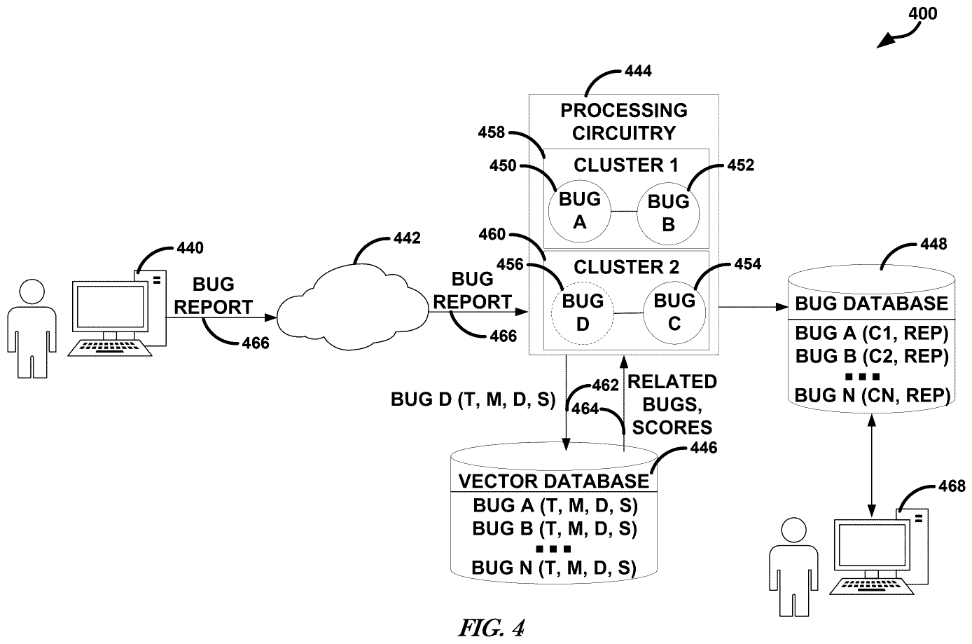

FIG. 4 illustrates, by way of example, a diagram of an embodiment of a CABGIM system 400 to implement the method 100 or a portion thereof. The system 400 as illustrated includes a user device 440, a network 442, processing circuitry 444, a vector database 446, and a bug database 448. A user accesses functionality of a software application using the user device 440. The user produces a bug report 466 that indicates a functionality, semantic, visual presentation, or other issue with the software application. The bug report 466 includes a title, description, and corresponding metadata of the bug. The title is a high-level description of the bug, such as a single sentence summary of the bug. The description is a lower-level description of the bug including the process through which the bug realized. The metadata indicates a time/date at which the bug presented, an operating system of the user device 440, a version of the software application, whether the software application is executed locally or in the cloud, a title of the software application, a combination thereof, or the like. The bug report 466 includes reproduction steps and one or more error log entries.

The network 442, sometimes called the cloud, provides network connectivity to communicate the bug report 466 to an entity that manages the software application. The network 442 can communicate the bug report to processing circuitry 444. The processing circuitry 444 operates on the bug report 466 to perform the operations of the method 100. The processing circuitry 444 issues a query 462 to the vector database 446. The query 462 indicates features of the bug (bug D 456 in the example of FIG. 4). The query 462 prompts the vector database 446 to identify bugs that are potentially related to the bug 456. The vector database 446 stores a history of bugs and their corresponding features. The vector database 446 compares the features of the bug 456 to the features of the historical bugs stored thereon. The vector database 446 provides a specified number of top matches, based on score, as comparison results 464.

The processing circuitry 444 determines which of a plurality of clusters 458, 460 the bug 456 is to be associated with, if any. In the example of FIG. 4 the bug 456 is determined to be related to bug C 454. Another cluster 458 of bugs 450, 452 is illustrated to indicate that there are multiple clusters of bugs. The processing circuitry 444 stores data related to the bug 456 in the bug data database 448. The bug database 448 indicates detailed data on each of the bugs. The detailed data can include the features of the bug, the bug report, the cluster to which the bug belongs, a combination thereof, or the like.

A bug mitigator uses another user device 468 to mitigate one or more of the bugs 450, 452, 454, 456. The bugs 450, 452, 454, 456 can be mitigated in priority order, such that a higher priority bug is mitigated before a lower priority bug. The priority of bugs can be determined per cluster or per bug, so that a cluster of higher priority bugs is mitigated before a cluster of lower priority bugs. Mitigating the bug can include altering text on a user interface, functionality of a component on a user interface, code of a software application, data on which the application relies, a combination thereof, or the like. Mitigating bugs improves user experience and even increases the security of the application, so as to reduce vulnerabilities of the application.

The CABGIM system 400, or a portion thereof, combines techniques in graph theory, machine learning (ML), and contextual analysis to create a scalable, precise, and adaptive solution for bug triaging. By integrating semantic, functional, and contextual dimensions, the CABGIM system 400, or a portion thereof, ensures accurate bug grouping, intent matching, and bug prioritization to improve software quality assurance. The following section provides a detailed example of how the CABGIM system operates, including the input bug data, intermediate steps, and final outputs. The examples cover multiple scenarios to illustrate the capability of the CABGIM system 400 for grouping, intent matching, and prioritization.

Consider a first example of bug grouping and deduplication. In this example, four bugs are reported with the following details:
1. Bug 1:
   Title: “App crashes when opening the calendar.”
   Description: “The app crashes every time I open the calendar tab after logging in.”
   Repro Steps:
      a. Log in to the app.
      b. Navigate to the calendar tab.
      c. Observe the crash.
   Platform: iOS
   Error Log: NullPointerException in CalendarViewRenderer.java
   Timestamp: 2023-10-01T14:00:00Z
2. Bug 2:
   Title: “Calendar crashes after login.”
   Description: “After logging into the app, switching to the calendar tab causes a crash.”
   Repro Steps:
      a. Log in to the app.
      b. Switch to the calendar tab.
      c. Crash occurs.
   Platform: iOS
   Error Log: NullPointerException in CalendarViewRenderer.java
   Timestamp: 2023-10-01T15:00:00Z
3. Bug 3:
   Title: “App crashes when syncing calendar.”
   Description: “The app crashes while syncing calendar events.”
   Repro Steps:
      a. Log in to the app.
      b. Navigate to the calendar tab.
      c. Start syncing events.
      d. Crash occurs.
   Platform: Android
   Error Log: IOException in CalendarSyncHandler.java
   Timestamp: 2023-10-01T16:00:00Z
4. Bug 4:
   Title: “Calendar sync timeout issue.”
   Description: “The calendar sync operation times out intermittently.”
   Repro Steps:
      a. Log in to the app.
      b. Navigate to the calendar tab.
      c. Start syncing events.
      d. Observe timeout error.
   Platform: Android
   Error Log: TimeoutException in CalendarSyncHandler.java
   Timestamp: 2023-10-01T17:00:00Z

To process these bugs, the processing circuitry 444 performs semantic analysis. Title and description embeddings (T, and D) are generated using a transformer model (e.g., BERT, GPT, or the like). Then semantic similarity is determined between bug pairs as: Bug 1↔Bug 2: High similarity (0.92); Bug 1↔Bug 3: Moderate similarity (0.68); Bug 3↔Bug 4: High similarity (0.88).

Functional analysis can be performed. Functional analysis includes generating functional intent signatures for the bugs. Functional intent signatures are generated based on reproduction steps and error logs. The functional similarity between the bug pairs can be determined as: Bug 1↔Bug 2: High similarity (1.0) (identical error logs and repro steps); Bug 1↔Bug 3: Low similarity (0.4) (different error logs and repro steps); and Bug 3↔Bug 4: High similarity (0.85) (similar repro steps and overlapping error logs).

Contextual analysis can be performed. Contextual analysis can include comparing metadata (e.g., platform, timestamp, version, or the like) of the bugs. The contextual analysis of the bug pairs can be determined as: Bug 1↔Bug 2: High contextual similarity (1.0) (same platform and close timestamps); Bug 1↔Bug 3: Low contextual similarity (0.3) (different platforms); and Bug 3↔Bug 4: High contextual similarity (0.9) (same platform and feature).

The results of the semantic analysis, functional analysis, and contextual analysis can be used to construct a bug relation graph. In the bug relation graph bugs can be represented as nodes, and edges can be weighted based on semantic, functional, and contextual similarities. The adjacency matrix that represents the bug relation graph can be determined. The adjacency matrix A can be constructed as:

$$A = [ \begin{matrix}1. & 0.9 & 0.5 & 0.3 \\ 0.9 & 1. & 0.45 & 0.25 \\ 0.5 & 0.45 & 1. & 0.85 \\ 0.3 & 0.25 & 0.85 & 1.\end{matrix} ] .$$

Clustering can then be performed based on the adjacency matrix, A. Using spectral clustering on A, two clusters can be realized. Cluster 1 can include Bug 1 and Bug 2 related to calendar crashes during navigation. Cluster 2 can include Bug 3 and Bug 4 (related to calendar sync issues).

The method 100 can provide data indicating clustered bugs and properties of the bugs in the clusters. The clustered bugs can include cluster 1 and cluster 2:
1. Cluster 1:
   Group Name: “Calendar Navigation Crashes”
   Bugs: Bug 1, Bug 2
   Functional Root Cause: NullPointerException in CalendarViewRenderer.java
   Platforms: iOS
   Priority: High (frequent recurrence, critical platform).
2. Cluster 2:
   Group Name: “Calendar Sync Issues”
   Bugs: Bug 3, Bug 4
   Functional Root Cause: IOException and TimeoutException in CalendarSyncHandler.java
   Platforms: Android
   Priority: Medium (platform-specific, lower recurrence).

An example of intent matching for a new bug is now provided. The input to the intent matching is a bug report, reproduction steps, and an error log entry. Example input can include:
Title: “App crashes when switching to calendar.”
Description: “Switching to the calendar tab after login causes the app to crash.”
Repro Steps:
   i. Log in to the app.
   ii. Navigate to the calendar tab.
   iii. Observe the crash.
Platform: iOS
Error Log: NullPointerException in CalendarViewRenderer.java

The processing steps for intent matching includes similarity scoring, threshold filtering, and dependency graph matching.

For similarity scoring, the new bug is compared against all existing bugs using semantic, functional, and contextual dimensions. In an example, the comparison can provide the following similarity scores:
New Bug↔Bug 1: High similarity (semantic: 0.95, functional: 1.0, contextual: 1.0).
New Bug↔Bug 2: High similarity (semantic: 0.93, functional: 1.0, contextual: 1.0).
New Bug↔Bug 3: Low similarity (semantic: 0.60, functional: 0.30, contextual: 0.20).

For threshold filtering, the similarity scores are compared to a specified criterion. The specified criterion in this example is 0.85. The result of threshold filtering in this example is that bugs 1 and 2 pass the similarity threshold (0.85) and are listed as potential matches.

For dependency graph matching, the dependency for Bugs 1 and 2 are compared to the dependency graph for the new bug. If the dependency graphs match the same root cause is confirmed. In this example, the new bug is determined to have a same intent as group 1 (“Calendar Navigation Crashes”). The new bug is added to the Group 1 cluster. The recurrence frequency for Group 1 is increased, raising its priority score.

An example of context-aware prioritization for a new bug is now provided. Consider three groups of bugs with the following contextual factors:
1. Group 1: “Calendar Navigation Crashes”
   Platform: iOS
   Recurrence Frequency: 5 reports
   Functional Impact: High (critical crash).
2. Group 2: “Calendar Sync Issues”
   Platform: Android
   Recurrence Frequency: 3 reports
   Functional Impact: Medium (sync failure).
3. Group 3: “UI Freezing on Login”
   Platform: iOS
   Recurrence Frequency: 8 reports
   Functional Impact: Low (non-blocking issue).

The processing steps for context-aware prioritization include determining the CPS for each group (cluster) of bugs, ranking the groups of bugs by CPS, and mitigating the group of bugs with the highest priority. In the example of three groups of bugs provided, these processing steps can provide results as follows:
1. Compute Contextual Priority Score (CPS):

$$CPS = α \cdot {W}_{p} + β \cdot {W}_{r} + γ \cdot {W}_{f}$$

Group 1: CPS=0.5×1.0+0.3×0.8+0.2×1.0=0.86
Group 2: CPS=0.5×0.7+0.3×0.6+0.2×0.8=0.68
Group 3: CPS=0.5×1.0+0.3×1.0+0.2×0.4=0.82
2. Rank Groups by CPS:
   Group 1: 0.86 (Highest Priority)
   Group 3: 0.82
   Group 2: 0.68
3. Prioritized Groups in Order:
1. Group 1: “Calendar Navigation Crashes” (Highest Priority)
2. Group 3: “UI Freezing on Login”
3. Group 2: “Calendar Sync Issues”

These examples provide concrete understanding of the CABGIM system ability to group related bugs based on semantic, functional, and contextual dimensions, match new bugs to existing groups using dependency graph analysis, and prioritize bug groups based on real-world impact factors, ensuring critical issues are addressed first. This comprehensive approach ensures precise, efficient, and impactful bug triaging in large-scale software systems.

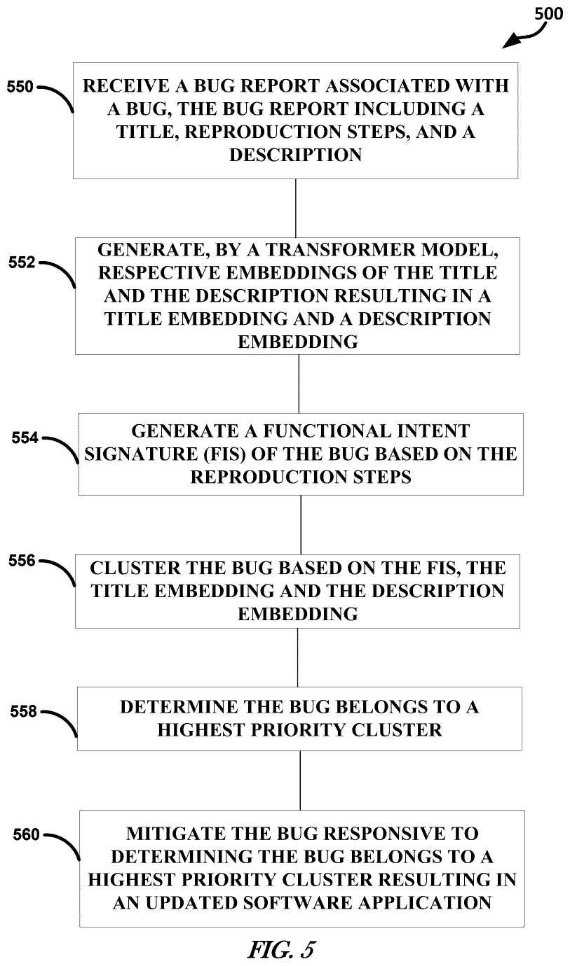

FIG. 5 illustrates, by way of example, a diagram of an embodiment of a method 500 for bug identification and mitigation. The method 500 as illustrated includes receiving a bug report associated with a bug, the bug report including a title, reproduction steps, and a description, at operation 550; generating, by a transformer model, respective embeddings of the title and the description resulting in a title embedding and a description embedding, at operation 552; generating a functional intent signature (FIS) of the bug based on the reproduction steps, at operation 554; clustering the bug based on the FIS, the title embedding and the description embedding, at operation 556; determining the bug belongs to a highest priority cluster, at operation 558; and mitigating the bug responsive to determining the bug belongs to a highest priority cluster resulting in an updated software application, at operation 560.

The bug report can further include metadata indicating a compute platform on which the bug was realized and a timestamp indicating a date and time at which the bug experienced. The method 500 can further include generating a metadata vector that indicates the metadata. The operation 556 can further be performed based on the metadata vector.

The method 500 can further include generating a graph in which the bug, and prior bugs, are represented as nodes and relationships between the nodes are indicated by labeled edges, the labeled edges including respective weight values indicating a likelihood that the bugs are related. The operation 556 can further be performed based on the graph.

The operation 554 can include determining probabilities of transitioning from a directly adjacent steps of the reproduction steps resulting in a transition matrix. The operation 554 can include determining Eigenvectors of the transition matrix. The FIS can be formed based on the determined Eigenvectors. The operation 554 can further include performing dimensionality reduction on the transition matrix, resulting in the FIS.

The operation 556 can include generating an adjacency matrix based on the graph, the adjacency matrix includes the bug, and the prior bugs, listed on columns and rows and entries include respective weight values indicating a likelihood that the bugs are related. The method 500 can include determining a graph Laplacian of the adjacency matrix. The method 500 can include determining Eigenvectors of the graph Laplacian, resulting in graph Eigenvectors. The method 500 can include clustering the bug represented by the graph based on the graph Eigenvectors. The method 500 can further include second clustering using hierarchical clustering.

The operation 556 can include matching an intent of the bug with corresponding intents of previously clustered bugs. Matching the intent can include identifying prior bugs with a similarity score that meet a specified criterion, the similarity scores indicate respective similarities between the titles, descriptions, and the FIS of respective prior bugs and the bug resulting in identified bugs. Matching the intent can further include comparing respective dependency graphs of the identified bugs to a dependency graph of the bug, the dependency graphs indicating code modules and file dependencies. Matching the intent can further include identifying identified bugs that most closely match the bug based on the dependency graphs.

The method 500 can further include determining a priority score for the bug and prior bugs based on a platform on which the bug was realized, how often the bug is reported, and the functionality of the software application that is affected by the bug. The method 500 can further include determining the bug belongs to the highest priority cluster by determining the bug is associated with a highest priority score.

To summarize, managing bug reports in large-scale software systems is a complex and resource-intensive process. Key challenges to managing bug reports and corresponding bugs include bug reports being duplicates in which similar bugs are reported multiple times with slight variations in language, leading to manual effort in deduplication; incorrect grouping where bugs with similar descriptions but different root causes are often grouped together incorrectly; evolving bug patterns fail to be managed properly with static clustering approaches that fail to adapt to new bug trends or feedback from triagers; there is a lack of prioritization context as current systems prioritize bugs based on severity without accounting for real-world factors like platform criticality or recurrence frequency; and there are complex dependencies with bugs caused by shared modules or interdependent code components that are not effectively identified.

The CABGIM system uses graph-based analysis, functional intent signatures, and adaptive clustering to address these challenges. The solution includes one or more multi-dimensional graph representation with bugs represented as nodes in a graph, with edges capturing semantic, functional, and contextual relationships, or a combination thereof. The functional intent signatures can be extracted from reproduction steps, stack traces, and error logs, these signatures differentiate bugs with similar text but distinct root causes. Adaptive Clustering with Feedback: Dynamically refines bug groups using spectral clustering and triager feedback. Dependency graph matching matches bugs with shared root causes by analyzing code dependencies and stack traces. Context-aware prioritization computes the CPS based on platform criticality, recurrence frequency, and functional impact.

Technical differences between CABGIM and prior bug management solutions include multi-dimensional analysis, functional intent signatures, adaptive clustering, dependency graph matching, and context-aware prioritization. Existing solutions focus primarily on NLP-based semantic similarity. CABGIM combines two or more of semantic, functional, and contextual dimensions for a holistic analysis of bug relationships. Existing solutions do not capture functional behavior, leading to incorrect grouping of bugs with similar language. CABGIM encodes execution flows and functional behavior, providing a unique identifier, the functional intent signature, for the root cause of each bug. Existing solutions use static clustering methods that cannot adapt to new bug patterns. CABGIM incorporates triager feedback and contrastive learning for dynamic threshold adjustments. Existing solutions ignore shared module and dependency relationships in bugs. CABGIM constructs dependency graphs and uses graph isomorphism to identify shared root causes. Existing solutions rely on severity and manual triaging for prioritization. CABGIM uses CPS to account for platform importance, recurrence frequency, and functional impact.

CABGIM provides greater precision, dynamic learning, scalability, time savings, improved software quality, or a combination thereof, as compared to existing solutions. CABGIM reduces false positives in bug grouping and deduplication through functional and contextual analysis. CABGIM adapts to evolving bug trends and feedback, ensuring long-term accuracy. CABGIM efficiently handles millions of bug reports using graph-based algorithms and vector databases. CABGIM automates bug grouping and prioritization, reducing triager workload. CABGIM ensures high-impact bugs are resolved first, leading to better user satisfaction.

The CABGIM system and techniques are useful for entities managing large bug repositories including enterprise software companies, consumer technology companies, gaming studios, software as a service providers, or the like. The CABGIM system and techniques are useful as a bug tracking tool, software maintenance tool, release management tool, and for bug analytics and insights, among others.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules may provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and may operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs)).

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus (e.g., a programmable processor, a computer, or multiple computers).

A computer program may be written in any form of programming language, including compiled or interpreted languages, and it may be deployed in any form, including as a stand-alone program or as a module, subroutine, or other unit suitable for use in a computing environment. A computer program may be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations may also be performed by, and apparatus of example embodiments may be implemented as, special purpose logic circuitry, e.g., a field programmable gate array (FPGA) or an application-specific integrated circuit (ASIC).

The computing system may include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium (e.g., Storage Device)

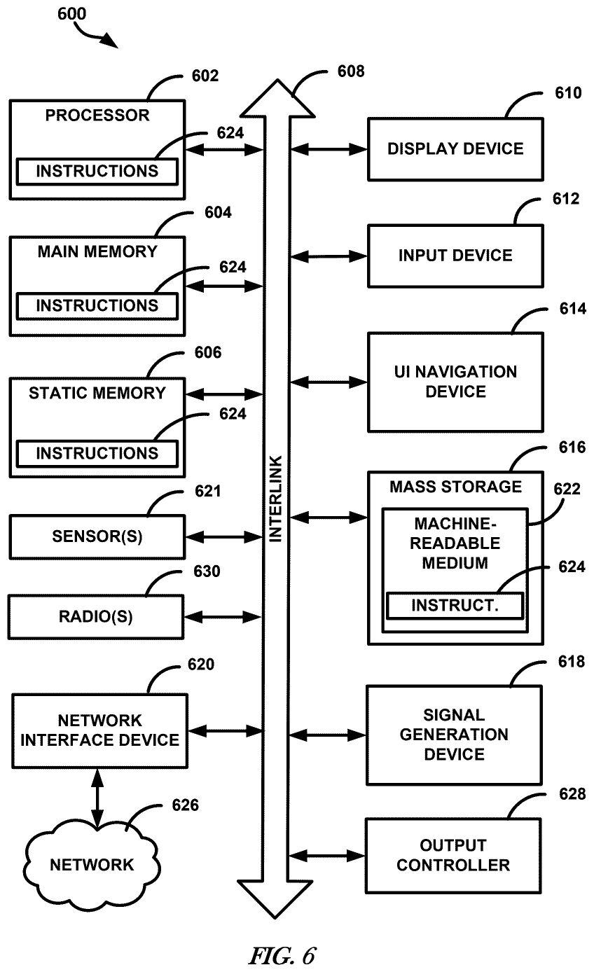

FIG. 6 illustrates, by way of example, a block diagram of an embodiment of a machine in the example form of a computer system 600 within which instructions, for causing the machine to perform any one or more of the methodologies discussed herein, may be executed. The CABGIM system, method 100, 200, 300, system 400, or a component thereof can be implemented using, or can include the system 600 or a component thereof. The CABGIM system, method 100, 200, 300, system 400, or a component or operation thereof can be implemented or performed by the computer system 600. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 600 includes a processor 602 (e.g., processing circuitry, such as can include a central processing unit (CPU), a graphics processing unit (GPU), field programmable gate array (FPGA), other circuitry, such as one or more transistors, resistors, capacitors, inductors, diodes, regulators, switches, multiplexers, power devices, logic gates (e.g., AND, OR, XOR, negate, etc.), buffers, memory devices, sensors 621 (e.g., a transducer that converts one form of energy (e.g., light, heat, electrical, mechanical, or other energy) to another form of energy), such as an IR, SAR, SAS, visible, or other image sensor, or the like, or a combination thereof), or the like, or a combination thereof), a main memory 604 and a static memory 606, which communicate with each other via a bus 608. The memory 604, 606 can store parameters (sometimes called weights) that define operations of the processing circuitry (e.g., the processor 602), an NN component, or other component of the system 600. The computer system 600 may further include a video display unit 610 (e.g., a liquid crystal display (LCD) or a cathode ray tube (CRT)). The computer system 600 also includes an alphanumeric input device 612 (e.g., a keyboard), a user interface (UI) navigation device 614 (e.g., a mouse), a disk drive unit 616, a signal generation device 618 (e.g., a speaker), a network interface device 620, and radios 630 such as Bluetooth, WWAN, WLAN, and NFC, permitting the application of security controls on such protocols. Note that a space vehicle does not typically include a display, UI navigation device, or the like.

The machine 600 as illustrated includes an output controller 628. The output controller 628 manages data flow to/from the machine 600. The output controller 628 is sometimes called a device controller, with software that directly interacts with the output controller 628 being called a device driver.

### Machine-Readable Medium

The disk drive unit 616 includes a machine-readable medium 622 on which is stored one or more sets of instructions and data structures (e.g., software) 624 embodying or utilized by any one or more of the methodologies or functions described herein. The instructions 624 may also reside, completely or at least partially, within the main memory 604, the static memory 606, and/or within the processor 602 during execution thereof by the computer system 600, the main memory 604 and the processor 602 also constituting machine-readable media.

While the machine-readable medium 622 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding or carrying instructions for execution by the machine and that cause the machine to perform any one or more of the methodologies of the present invention, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

### Transmission Medium

The instructions 624 may further be transmitted or received over a communications network 626 using a transmission medium. The instructions 624 may be transmitted using the network interface device 620 and any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., WiFi and WiMax networks). The term “transmission medium” shall be taken to include any intangible medium that is capable of storing, encoding, or carrying instructions for execution by the machine, and includes digital or analog communications signals or other intangible media to facilitate communication of such software.

### Additional Notes and Examples

Example 1 includes a method for bug mitigation in a software application, the method comprising receiving a bug report associated with a bug, the bug report including a title, reproduction steps, and a description, generating, by a transformer model, respective embeddings of the title and the description resulting in a title embedding and a description embedding, generating a functional intent signature (FIS) of the bug based on the reproduction steps, clustering the bug based on the FIS, the title embedding and the description embedding, determining the bug belongs to a highest priority cluster, and mitigating the bug responsive to determining the bug belongs to a highest priority cluster resulting in an updated software application.

In Example 2, Example 1 further includes, wherein the bug report further includes metadata indicating a compute platform on which the bug was realized and a timestamp indicating a date and time at which the bug experienced.

In Example 3, Example 2 further includes generating a metadata vector that indicates the metadata, and wherein the clustering is further performed based on the metadata vector.

In Example 4, at least one of Examples 1-3 further includes generating a graph in which the bug, and prior bugs, are represented as nodes and relationships between the nodes are indicated by labeled edges, the labeled edges including respective weight values indicating a likelihood that the bugs are related, and wherein the clustering is further performed based on the graph.

In Example 5, at least one of Examples 1-4 further includes, wherein generating the FIS includes determining probabilities of transitioning from a directly adjacent steps of the reproduction steps resulting in a transition matrix, and determining Eigenvectors of the transition matrix, wherein the FIS is formed based on the determined Eigenvectors.

In Example 6, Example 5 includes, wherein generating the FIS further includes performing dimensionality reduction on the transition matrix, resulting in the FIS.

In Example 7, at least one of Examples 4-6 further includes, wherein the clustering includes generating an adjacency matrix based on the graph, the adjacency matrix includes the bug, and the prior bugs, listed on columns and rows and entries include respective weight values indicating a likelihood that the bugs are related.

In Example 8, Example 7 further includes determining a graph Laplacian of the adjacency matrix, determining Eigenvectors of the graph Laplacian, resulting in graph Eigenvectors, and clustering the bug represented by the graph based on the graph Eigenvectors.

In Example 9, Example 8 further includes second clustering using hierarchical clustering.

In Example 10, at least one of Examples 1-9 further includes, wherein clustering the bug includes matching an intent of the bug with corresponding intents of previously clustered bugs.

In Example 11, Example 10 further includes, wherein matching the intent includes identifying prior bugs with a similarity score that meet a specified criterion, the similarity scores indicate respective similarities between the titles, descriptions, and the FIS of respective prior bugs and the bug resulting in identified bugs.

In Example 12, Example 11 further includes, wherein matching the intent further includes comparing respective dependency graphs of the identified bugs to a dependency graph of the bug, the dependency graphs indicating code modules and file dependencies, and identifying identified bugs that most closely match the bug based on the dependency graphs.

In Example 13, at least one of Examples 1-12 further includes determining a priority score for the bug and prior bugs based on a platform on which the bug was realized, how often the bug is reported, and the functionality of the software application that is affected by the bug.

In Example 14, Example 13 further includes determining the bug belongs to the highest priority cluster by determining the bug is associated with a highest priority score.

Example 15 includes a method comprising receiving a bug report associated with a bug, the bug report including a title, reproduction steps, and a description, generating, based on the bug report, a graph representing relationships between the bug and prior bugs, the graph including the bug, and the prior bugs represented as nodes and the relationships between the nodes are indicated by labeled edges, the labeled edges including respective weight values indicating a likelihood that the bugs are related, generating an adjacency matrix based on the graph, the adjacency matrix includes the bug, and the prior bugs, listed on columns and rows and entries include respective weight values indicating a likelihood that the bugs are related, clustering the bug based on the adjacency matrix, and mitigating the bug responsive to determining the bug belongs to a cluster whose priority satisfies a specified criterion.

Example 16 includes a non-transitory machine-readable medium including instructions that, when executed by a machine, cause the machine to perform operations for bug mitigation, the operations comprising the method of at least one of Examples 1-15.

Example 17 includes a vector database storing bug identifications and corresponding features, the features including a title embedding, a description embedding, and a functional intent signature (FIS) for each of the bugs, a bug database storing the bug identifications and corresponding bug reports and cluster data for each of the bugs, the cluster data indicating a cluster of which the bug is a member; and processing circuitry configured to receive a new bug report, query the vector database to determine which bug associated with the bug identifications is most similar to bug associated with the bug report resulting in a most similar bug, discard the bug report responsive to determining the bug associated with the bug report is identical to the most similar bug, increment a recurrence value associated with the cluster of which the most similar bug is a member resulting in an incremented recurrence value, and increasing a priority value of the cluster based on the incremented recurrence value.

In Example 18, Example 17 further includes, wherein the processing circuitry is further configured to determine the FIS based on a graph in which the bug, and prior bugs, are represented as nodes and relationships between the nodes are indicated by labeled edges, the labeled edges including respective weight values indicating a likelihood that the bugs are related.

Although teachings have been described with reference to specific example teachings, it will be evident that various modifications and changes may be made to these teachings without departing from the broader spirit and scope of the teachings. Accordingly, the specification and drawings are to be regarded in an illustrative rather than a restrictive sense. The accompanying drawings that form a part hereof, show by way of illustration, and not of limitation, specific teachings in which the subject matter may be practiced. The teachings illustrated are described in sufficient detail to enable those skilled in the art to practice the teachings disclosed herein. Other teachings may be utilized and derived therefrom, such that structural and logical substitutions and changes may be made without departing from the scope of this disclosure. This Detailed Description, therefore, is not to be taken in a limiting sense, and the scope of various teachings is defined only by the appended claims, along with the full range of equivalents to which such claims are entitled.

What is claimed is:

1. A method for bug mitigation in a software application, the method comprising:
receiving a bug report associated with a bug, the bug report including a title, reproduction steps, and a description;
generating, by a transformer model, respective embeddings of the title and the description resulting in a title embedding and a description embedding;
generating a functional intent signature (FIS) of the bug based on the reproduction steps;
clustering the bug based on the FIS, the title embedding and the description embedding;
determining the bug belongs to a highest priority cluster; and
mitigating the bug responsive to determining the bug belongs to a highest priority cluster resulting in an updated software application.

2. The method of claim 1, wherein the bug report further includes metadata indicating a compute platform on which the bug was realized and a timestamp indicating a date and time at which the bug experienced.

3. The method of claim 2, further comprising:
generating a metadata vector that indicates the metadata; and
wherein the clustering is further performed based on the metadata vector.

4. The method of claim 1, further comprising:
generating a graph in which the bug, and prior bugs, are represented as nodes and relationships between the nodes are indicated by labeled edges, the labeled edges including respective weight values indicating a likelihood that the bugs are related; and
wherein the clustering is further performed based on the graph.

5. The method of claim 1, wherein generating the FIS includes:
determining probabilities of transitioning from a directly adjacent steps of the reproduction steps resulting in a transition matrix; and
determining Eigenvectors of the transition matrix;
wherein the FIS is formed based on the determined Eigenvectors.

6. The method of claim 5, wherein generating the FIS further includes performing dimensionality reduction on the transition matrix, resulting in the FIS.

7. The method of claim 4, wherein the clustering includes generating an adjacency matrix based on the graph, the adjacency matrix includes the bug, and the prior bugs, listed on columns and rows and entries include respective weight values indicating a likelihood that the bugs are related.

8. The method of claim 7, further comprising:
determining a graph Laplacian of the adjacency matrix;
determining Eigenvectors of the graph Laplacian, resulting in graph Eigenvectors; and
clustering the bug represented by the graph based on the graph Eigenvectors.

9. The method of claim 8, further comprising second clustering using hierarchical clustering.

10. The method of claim 1, wherein clustering the bug includes matching an intent of the bug with corresponding intents of previously clustered bugs.

11. The method of claim 10, wherein matching the intent includes identifying prior bugs with a similarity score that meet a specified criterion, the similarity scores indicate respective similarities between the titles, descriptions, and the FIS of respective prior bugs and the bug resulting in identified bugs.

12. The method of claim 11, wherein matching the intent further includes:
comparing respective dependency graphs of the identified bugs to a dependency graph of the bug, the dependency graphs indicating code modules and file dependencies; and
identifying identified bugs that most closely match the bug based on the dependency graphs.

13. The method of claim 1, further comprising determining a priority score for the bug and prior bugs based on a platform on which the bug was realized, how often the bug is reported, and the functionality of the software application that is affected by the bug.

14. The method of claim 13, further comprising determining the bug belongs to the highest priority cluster by determining the bug is associated with a highest priority score.

15. A non-transitory machine-readable medium including instructions that, when executed by a machine, cause the machine to perform operations for bug mitigation, the operations comprising:
receiving a bug report associated with a bug, the bug report including a title, reproduction steps, and a description;
generating, based on the bug report, a graph representing relationships between the bug and prior bugs, the graph including the bug, and the prior bugs represented as nodes and the relationships between the nodes are indicated by labeled edges, the labeled edges including respective weight values indicating a likelihood that the bugs are related;
generating an adjacency matrix based on the graph, the adjacency matrix includes the bug, and the prior bugs, listed on columns and rows and entries include respective weight values indicating a likelihood that the bugs are related;
clustering the bug based on the adjacency matrix; and
mitigating the bug responsive to determining the bug belongs to a cluster whose priority satisfies a specified criterion.

16. The non-transitory machine-readable medium of claim 15, wherein the operations further comprise:
generating respective embeddings of the title and the description resulting in a title embedding and a description embedding;
generating a functional intent signature (FIS) of the bug based on the reproduction steps;
and wherein the relationships between the bug and the prior bugs is determined based on the title embedding, the description embedding, and the reproduction steps.

17. The non-transitory machine-readable medium of claim 16, wherein generating the FIS includes:
determining probabilities of transitioning from a directly adjacent steps of the reproduction steps resulting in a transition matrix; and
determining Eigenvectors of transition matrix;
wherein the FIS is formed based on the determined Eigenvectors.

18. The non-transitory machine-readable medium of claim 17, wherein generating the FIS further includes performing dimensionality reduction on the transition matrix, resulting in the FIS.

19. A system comprising:
a vector database storing bug identifications and corresponding features, the features including a title embedding, a description embedding, and a functional intent signature (FIS) for each of the bugs;
a bug database storing the bug identifications and corresponding bug reports and cluster data for each of the bugs, the cluster data indicating a cluster of which the bug is a member; and
processing circuitry configured to:
receive a new bug report;
query the vector database to determine which bug associated with the bug identifications is most similar to bug associated with the bug report resulting in a most similar bug;
discard the bug report responsive to determining the bug associated with the bug report is identical to the most similar bug; and
increment a recurrence value associated with the cluster of which the most similar bug is a member resulting in an incremented recurrence value; and
increasing a priority value of the cluster based on the incremented recurrence value.

20. The system of claim 19, wherein the processing circuitry is further configured to determine the FIS based on a graph in which the bug, and prior bugs, are represented as nodes and relationships between the nodes are indicated by labeled edges, the labeled edges including respective weight values indicating a likelihood that the bugs are related.
